(19) United States
(12) Patent Application Publication
(10) Pub. No.: US 2026/0209089 A1
(43) Pub. Date: Jul. 23, 2026

(54) SYSTEM AND METHOD FOR PHOTOVOLTAIC CAPACITIVE DEIONIZATION

(71) Applicant: ECOLE DE TECHNOLOGIE SUPERIEURE, Montréal (CA)

(72) Inventors: Alaa GHAMRAWI, L'Île-Perrot (CA); Maarouf SAAD, Montréal (CA); Imad MOUGHARBEL, Saint-Laurent (CA)

(21) Appl. No.: 19/140,143

(22) PCT Filed: Dec. 20, 2023
(86) PCT No.: PCT/CA2023/051716

§ 371 Date: Jun. 17, 2025

Related U.S. Application Data
(60) Provisional application No. 63/434,864, filed on Dec. 22, 2022.

(51) Int. Cl. C02F 1/469

(52) U.S. Cl. CPC C02F 1/4691; C02F 2201/46145; C02F 2209/003; C02F 2209/05; C02F 2209/40

(57) ABSTRACT

There is provided a method for controlling at least one capacitive deionization (CDI) cell used for water desalination. The method comprises subsequent to feeding the at least one CDI cell with water at an initial flow rate, obtaining a measurement of an actual output concentration of water exiting the at least one CDI cell, comparing the actual output concentration to a concentration setpoint, determining, based on the comparing, a change to be applied to the initial flow rate for adjusting the output concentration towards the concentration setpoint, and outputting at least one control signal comprising instructions to cause the change to be applied to the initial flow rate to obtain a modified flow rate and to cause the at least one CDI cell to be fed with water at the modified flow rate.

### CROSS-REFERENCE TO RELATED APPLICATIONS

The present application claims priority on U.S. Patent Application No. 63/434,864 filed Dec. 22, 2022, the entire contents of which are incorporated herein by reference.

### FIELD

The improvements generally relate to the field of desalination, and more particularly to the use of photovoltaic (PV) capacitive deionization (CDI) for desalination.

### BACKGROUND

Photovoltaic (PV) systems may be used as an eco-friendly energy source for desalination applications. Through the use of solar panels that supply electrical power to capacitive deionization (CDI) cells of desalination plants, self-energized desalination plants can be achieved. In order to extract the maximum power from the solar panels, equipment, such as batteries, energy storage devices, direct current (DC)-to-DC converters, and the like, is generally used. However, the use of such equipment increases system complexity and costs. In addition, the desalination operation becomes limited by the capacity of the batteries and energy storage devices, thus reducing system efficiency.

Therefore, there is room for improvement.

### SUMMARY

In accordance with one aspect, there is provided a method for controlling at least one capacitive deionization (CDI) cell used for water desalination. The method comprises subsequent to feeding the at least one CDI cell with water at an initial flow rate, obtaining a measurement of an actual output concentration of water exiting the at least one CDI cell, comparing the actual output concentration to a concentration setpoint, determining, based on the comparing, a change to be applied to the initial flow rate for adjusting the output concentration towards the concentration setpoint, and outputting at least one control signal comprising instructions to cause the change to be applied to the initial flow rate to obtain a modified flow rate and to cause the at least one CDI cell to be fed with water at the modified flow rate.

In at least one embodiment in accordance with any previous/other embodiment described herein, the at least one CDI cell is fed with electrical power from at least one solar panel, the method further comprising determining a change in power consumed by the at least one CDI cell subsequent to feeding the at least one CDI cell with water at the initial flow rate, and the change to be applied to the initial flow rate being further determined based on the change in power consumed by the at least one CDI cell.

In at least one embodiment in accordance with any previous/other embodiment described herein, determining the change to be applied to the initial flow rate comprises determining a decrease in the initial flow rate when the actual output concentration is greater than or equal to the concentration setpoint.

In at least one embodiment in accordance with any previous/other embodiment described herein, the change in power consumed by the at least one CDI cell is determined when the actual output concentration is lower than the concentration setpoint.

In at least one embodiment in accordance with any previous/other embodiment described herein, determining the change to be applied to the initial flow rate comprises determining an increase in the initial flow rate when the actual output concentration is lower than the concentration setpoint and the change in power consumed by the at least one CDI cell is positive.

In at least one embodiment in accordance with any previous/other embodiment described herein, determining the change to be applied to the initial flow rate comprises determining the decrease in the initial flow rate when the actual output concentration is lower than the concentration setpoint and the change in power consumed by the at least one CDI cell is negative.

In at least one embodiment in accordance with any previous/other embodiment described herein, feeding the at least one CDI cell with water comprises feeding multiple CDI cells connected in series.

In at least one embodiment in accordance with any previous/other embodiment described herein, feeding the at least one CDI cell with water comprises feeding multiple CDI cells connected in parallel.

In at least one embodiment in accordance with any previous/other embodiment described herein, feeding the at least one CDI cell with water comprises feeding multiple CDI cells arranged in a combination of a series arrangement and a parallel arrangement.

In accordance with another aspect, there is provided a system for controlling at least one capacitive deionization (CDI) cell used for water desalination. The system comprises a processing unit, and a non-transitory memory communicatively coupled to the processing unit and comprising computer-readable program instructions executable by the processing unit for, subsequent to feeding the at least one CDI cell with water at an initial flow rate, obtaining a measurement of an actual output concentration of water exiting the at least one CDI cell, comparing the actual output concentration to a concentration setpoint, determining, based on the comparing, a change to be applied to the initial flow rate for adjusting the output concentration towards the concentration setpoint, and outputting at least one control signal comprising instructions to cause the change to be applied to the initial flow rate to obtain a modified flow rate and to cause the at least one CDI cell to be fed with water at the modified flow rate.

In at least one embodiment in accordance with any previous/other embodiment described herein, the at least one CDI cell is fed with electrical power from at least one solar panel, and the instructions are executable by the processing unit for determining a change in power consumed by the at least one CDI cell subsequent to feeding the at least one CDI cell with water at the initial flow rate, the change to be applied to the initial flow rate being further determined based on the change in power consumed by the at least one CDI cell.

In at least one embodiment in accordance with any previous/other embodiment described herein, the instructions are executable by the processing unit for determining the change to be applied to the initial flow rate comprising determining a decrease in the initial flow rate when the actual output concentration is greater than or equal the concentration setpoint.

In at least one embodiment in accordance with any previous/other embodiment described herein, the instructions are executable by the processing unit for determining the change in power consumed by the at least one CDI cell when the actual output concentration is lower than the concentration setpoint.

In at least one embodiment in accordance with any previous/other embodiment described herein, the instructions are executable by the processing unit for determining the change to be applied to the initial flow rate comprising determining an increase in the initial flow rate when the actual output concentration is lower than the concentration setpoint and the change in power consumed by the at least one CDI cell is positive.

In at least one embodiment in accordance with any previous/other embodiment described herein, the instructions are executable by the processing unit for determining the change to be applied to the initial flow rate comprising determining the decrease in the initial flow rate when the actual output concentration is lower than the concentration setpoint and the change in power consumed by the at least one CDI cell is negative.

In at least one embodiment in accordance with any previous/other embodiment described herein, the at least one CDI cell comprises multiple CDI cells connected in series.

In at least one embodiment in accordance with any previous/other embodiment described herein, the at least one CDI cell comprises multiple CDI cells connected in parallel.

In at least one embodiment in accordance with any previous/other embodiment described herein, the at least one CDI cell comprises multiple CDI cells arranged in a combination of a series arrangement and a parallel arrangement.

In accordance with another aspect, there is provided a non-transitory computer readable medium having stored thereon program code executable by a processor for subsequent to feeding at least one capacitive deionization (CDI) cell with water at an initial flow rate, obtaining a measurement of an actual output concentration of water exiting the at least one CDI cell, comparing the actual output concentration to a concentration setpoint, determining, based on the comparing, a change to be applied to the initial flow rate for adjusting the output concentration towards the concentration setpoint, and outputting at least one control signal comprising instructions to cause the change to be applied to the initial flow rate to obtain a modified flow rate and to cause the at least one CDI cell to be fed with water at the modified flow rate.

Many further features and combinations thereof concerning embodiments described herein will appear to those skilled in the art following a reading of the instant disclosure.

### DESCRIPTION OF THE FIGURES

In the figures,

FIG. 1 is a circuit diagram of example of a Photovoltaic (PV)-Capacitive Deionization (CDI) system, in accordance with one embodiment;

FIG. 2 is a plot of the voltage of the CDI cell of FIG. 1 as a function of the water flow rate through the CDI cell, in accordance with one embodiment;

FIG. 3 is a schematic diagram of a closed-control loop performed on the CDI cell of FIG. 1, in accordance with one embodiment;

FIG. 4 is a flowchart of a method for controlling the water flow rate through the CDI cell of FIG. 1, in accordance with one embodiment;

FIG. 5A is a schematic diagram of a test bench for controlling the water flow through the CDI cell of FIG. 1, in accordance with one embodiment;

FIG. 5B is a schematic diagram illustrating the operation of the MCDI cells of FIG. 5A, in accordance with one embodiment;

FIG. 6A is a plot illustrating the evolution of the solar voltage applied to an MCDI cell, the voltage of the MCDI cell, and the solar current following application of water at a flow rate of 7.5 ml/s, in accordance with one embodiment;

FIG. 6B is a plot illustrating the evolution of the solar voltage applied to an MCDI cell of FIG. 5A, the voltage of the MCDI cell, and the solar current following application of water at a flow rate of 9.0 ml/s, in accordance with one embodiment;

FIG. 6C is a plot of the input concentration, the output concentration when the flow rate is 9.0 ml/s, and the output concentration when the flow rate is 7.5 ml/s, as a function oft time, for an MCDI cell, in accordance with one embodiment;

FIG. 6D is a plot of the average irradiance profile, solar power, flow rate to the MCDI cell, and produced water volume as a function of time, in accordance with one embodiment;

FIG. 6E is a plot of the produced water volume obtained using the method of FIG. 4 versus the produced water volume obtained using conventional techniques, in accordance with one embodiment; and

FIG. 7 is a schematic diagram of computing device, in accordance with one embodiment.

It will be noticed that throughout the appended drawings, like features are identified by like reference numerals.

### DETAILED DESCRIPTION

Described herein are systems and methods for desalination using Photovoltaic (PV) Capacitive Deionization (CDI). One or more solar panels (each comprising a plurality of PV cells) are used to supply one or more CDI cells of a desalination plant with electrical energy, which is in turn used by the CDI cell(s) to perform a desalination operation on a target substance (e.g., saline water, brackish water, briny water, etc.). As used herein, the term “desalination” refers to a process by which salts and mineral components are removed from the target substance. For example, saline water (which contains a high concentration of dissolved salts) may be desalinated to produce water that is suitable for purposes such as human consumption and irrigation. It is proposed herein to control the flow rate of the target substance (e.g., saline water) passing through the CDI cell(s) based on the level of solar irradiance and on the produced power of the solar panel(s), as will be discussed further below. In this manner, it becomes possible to extract the maximum possible energy from the solar panel(s) (also referred to as “maximum power point tracking” (MPPT)) and to maximize salt removal from the target substance (e.g., using an adapted salt tracking technique referred to as “Maximum Salt Adsorption Tracking” or MSAT).

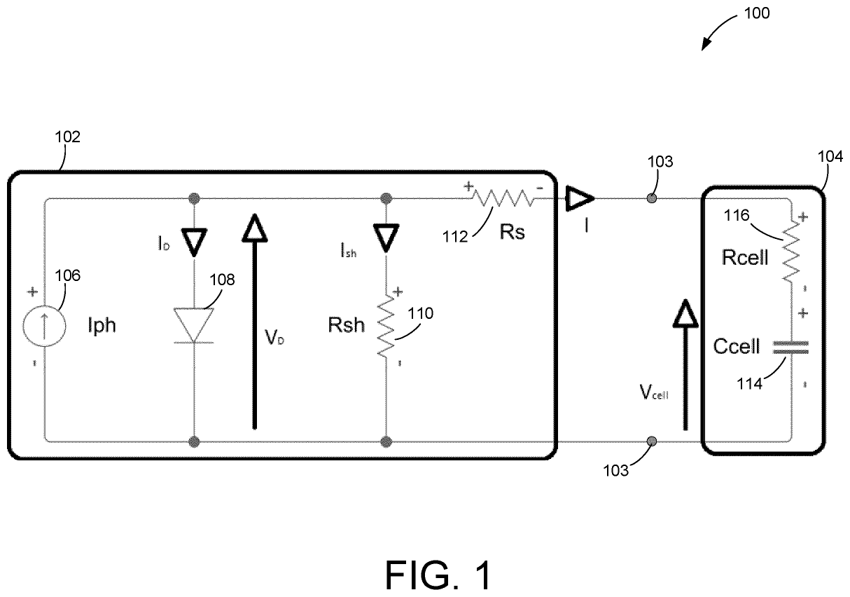

FIG. 1 shows an example of an electrical circuit diagram of a PV-CDI system 100. The PV-CDI system 100 comprises a solar panel 102 electrically connected to a CDI cell 104. Although a single solar panel 102 is illustrated and described herein, it should be understood that the PV-CDI system 100 may comprise multiple solar panels as in 102 arranged in an array, with each solar panel 102 comprising one or more PV cells (not shown) which may be interconnected in any suitable manner. For example, the solar panels as in 102 may be arranged in series, in parallel, and/or in a combination of a series arrangement and a parallel arrangement, depending on the power requirement. In addition, although a single CDI cell 104 is illustrated 170 and described herein, it should be understood that the PV-CDI system 100 may comprise more than one CDI cell as in 104 and any suitable number of CDI cells may apply. In particular, a plurality of CDI cells as in 104 may be arranged in series and/or in parallel, depending on the application. For example, a parallel arrangement may be used when a high flow demand for a limit salt removal is desired. In this case, the CDI cells 104 may be mounted on a same head and their flow may be conducted to a same tank. A series arrangement may alternatively be used when a low concentration is desired for a low water flow. In this case, a buffer tank may be installed between the CDI cells 104 in order to retain the possibility of controlling the flow and not be concerned with a lack of water of lower flow produced in upstream CDI cell(s) 104. A matrix arrangement may also be used, in which the CDI cells 104 are arranged in a combination of a series arrangement and a parallel arrangement. In this case, it may be desirable to design the buffer tank in order to separate the stages of each string of parallel CDI cells 104.

The solar panel 102 is configured to capture a portion of the electromagnetic radiation from the Sun as a source of radiant energy and to convert this radiation into electrical power, in the form of direct current (DC) power. The input of the solar panel 102 is directly applied to terminals 103 of the CDI cell 104 such that the solar panel 102 directly supplies the generated DC power to the CDI cell 104, thereby eliminating the need for providing a battery (or other energy storage device) between the solar panel 102 and the CDI cell 104.

The CDI cell 104 is then configured to perform a desalination operation on a target substance (e.g., saline water, referred to herein as “feed water” or “influent”) flowing therethrough (e.g., feed water fed by a pump, not shown, supplied with the feed water from a water tank, not shown). The CDI process is based on potential-induced capacitive adsorption of ions on the surface of a charged carbon electrode. The process mainly comprises two phases: a adsorption phase and a desorption phase. In the adsorption phase, a charging electrical voltage is applied on the terminals 103 of the CDI cell 104 which causes a voltage potential difference to be created between two electrodes (i.e. a cathode electrode and an anode electrode, not shown) of the CDI cell 104 and ions to migrate towards the charged electrode. The resulting electrostatic force on the electrodes keeps the ions on the charged electrode. This increases the voltage of the CDI cell 104 and the feed water is desalted. As used herein, the term “input concentration” refers to the concentration of ions in the feed water that flow into the CDI cell 104, and the term “output concentration” (or “effluent concentration”) refers to the concentration of ions in the water (i.e. desalted water) obtained at the output of the CDI cell 104 (such water being also referred to as “effluent”).

After the electrical potential on the terminals 103 of the CDI cell 104 reaches its maximal allowable limit (e.g., between 0.8 V and 2.0 V), the electrodes reach their maximum capacity of ions and the desorption phase takes place. In the desorption phase, a reversed voltage is applied (or the terminals 103 of the CDI cell 104 are shorted to remove the voltage from the terminals 103) to repel the ions from the electrodes and return the repelled ions into the flushing stream of feed water. The desorption phase ends once the CDI cell voltage reaches zero volts, so that all ions from the electrodes of the CDI cell 104 have been completely desorbed. After restoring its adsorption capacity, the CDI cell 104 is ready for a new adsorption phase.

In one embodiment, the CDI cell 104 is a Membrane Capacitive Deionization (MCDI) cell, which may allow to achieve an improved salt removal efficiency compared to a standard CDI cell. MCDI is a modified form of CDI in which ion-exchange membranes are introduced between the electrodes of the CDI cell 104. In particular, a cation exchange membrane is provided on the surface of the cell's anode electrode, and an anion exchange membrane is provided on the surface of the cell's cathode electrode. It should however be understood that the CDI cell 104 may be a cell of a different type than MCDI including, but not limited to, Flow-electrode capacitive deionization (FCDI), iCDI, and hybrid CDI.

Still referring to FIG. 1, the solar panel 102 comprises a photo-generated current source 106 electrically connected in parallel with a diode 108 and a shunt resistor 110 having a resistance Rₛₕ. A current Iₚₕ flows through the photo-generated current source 106. The diode 108 has a leakage current I₀, a current I_{D} flowing therethrough, and a voltage V_{D} across its terminals (not shown). The shunt resistor 110 has a current Iₛₕ flowing therethrough. The shunt resistor 110 is electrically connected in series with a resistor 112 having a resistance Rₛ (which is representative of the serial resistance of the solar panel 102).

In FIG. 1, the CDI cell 104 is represented by a capacitor 114 having a capacitance Ccell (which is the equivalent capacitance of the CDI cell 104) and a voltage V_{cell} across its terminals (not shown), and a resistor 116 having a resistance R_{cell} (which represents the serial resistance of the CDI cell 104). The capacitor 114 is electrically connected in series with the cell resistor 116. The CDI cell 104 has a charging current I flowing therethrough (from the solar panel 102).

Considering that Rₛₕ>>(Rₛ+R_{cell}), which means that Iₛₕ<<I, and applying Kirchhoff's current and voltage laws to the electrical circuit of the PV-CDI system 100 shown in FIG. 1, the following equations are obtained:

$${I}_{D} + I = {I}_{p h} \qquad ( 1 )$$

$$( {R}_{S} + {R}_{cell} ) I + {V}_{cell} = {V}_{D} \qquad ( 2 )$$

The following first order differential equations are therefore obtained:

$$\frac{{dI}_{D}}{dt} + \frac{dI}{dt} = \frac{{dI}_{p h}}{dt} \qquad ( 3 )$$

$$( {R}_{S} + {R}_{cell} ) \cdot \frac{dI}{dt} + \frac{{dV}_{cell}}{dt} = \frac{{dV}_{D}}{dt} \qquad ( 4 )$$

As for the characteristic of the diode 108, the current Ip flowing through the diode 108 may be written as:

$${I}_{D} = {I}_{0} \cdot ( {\text{?}}^{\frac{{V}_{D}}{{AN}_{T}}} - 1 ) \qquad ( 5 )$$

$$\text{?} \text{indicates text missing or illegible when filed}$$

The diode voltage V_{D} can be presented as follows:

$${V}_{D} = {V}_{T} \cdot ln ( \frac{{I}_{D} + {I}_{0}}{{I}_{o}} ) \qquad ( 6 )$$

where V_{T} refers to the thermal voltage, which is the voltage produced within a P-N junction due to the action of temperature. V_{T} is computed as kT/q, where k is Boltzmann's constant (1.38×10⁻²³), T is the Kelvin temperature, and q is the electron charge (1.6×10⁻¹⁹ coulombs). At room temperature, V_{T} is about 26 millivolts.

As for the CDI cell 104, the voltage V_{cell} may be written as follows:

$$\frac{{dV}_{cell}}{dt} = \frac{I}{{C}_{cell}} \qquad ( 7 )$$

As for the diode 108, using equation (1) in equation (6), the voltage V_{D} becomes:

$${V}_{D} = {V}_{T} \cdot ln ( \frac{{I}_{p h} - I + {I}_{0}}{{I}_{0}} ) \qquad ( 8 )$$

Deriving equation (8) will give:

$$\frac{{dV}_{D}}{dt} = - {V}_{T} \cdot \frac{\frac{dI}{dt}}{{I}_{p h} - I + {I}_{0}} \qquad ( 9 )$$

$$( {R}_{S} + {R}_{cell} + \frac{{V}_{T}}{{I}_{p h} - I - {I}_{0}} ) \frac{dI}{dt} + \frac{I}{{C}_{cell}} = 0 \qquad ( 10 )$$

$$( {R}_{S} + {R}_{cell} ) \frac{dI}{dt} + \frac{{V}_{T}}{{I}_{p h} - I + {I}_{0}} \frac{dI}{dt} + \frac{I}{{C}_{cell}} = 0 \qquad ( 11 )$$

Equation (11) is then integrated as follows:

$$\int {C}_{cell} \cdot ( {R}_{S} + {R}_{cell} ) \frac{dI}{I} + \int \frac{{C}_{cell} \cdot {V}_{T}}{{I}_{p h} - I + {I}_{0}} \frac{dI}{I} + \int dt = K \qquad ( 12 )$$

$${C}_{cell} \cdot ( {R}_{S} + {R}_{cell} ) ln I + \frac{{C}_{cell} \cdot {V}_{T}}{{I}_{p h} + {I}_{0}} ln I = \frac{{C}_{cell} \cdot {V}_{T}}{{I}_{p h} + {I}_{0}} ln ( {I}_{p h} - I + {I}_{0} + t = K \qquad ( 13 )$$

where K is the flow rate of feed water passing through the CDI cell 104 (referred to herein as the “water flow rate”).

Since, in one embodiment, the resistor 114 of the CDI cell 104 and the serial resistor 112 of the solar panel 102 have resistance values R_{cell} and Rₛ that are too small to affect the charging current I the CDI cell 104, the resistance values R_{cell} and Rₛ may be neglected in the calculation. The value of K is then obtained from initial conditions defined as Iₜ₌₀=Iₚₕ, so the CDI cell's charging current as a function of time (referred to as I(t)) may be written as:

$$I ( t ) = I = \frac{{I}_{p h} - {I}_{0}}{1 + \frac{{I}_{0}}{{I}_{p h}} \cdot {\text{?}}^{t \cdot \frac{{I}_{p h} + {I}_{0}}{{C}_{cell} \cdot {V}_{T}}}} \qquad ( 14 )$$

$$\text{?} \text{indicates text missing or illegible when filed}$$

And the voltage V_{cell} of the CDI cell 104 may be written as:

$${V}_{cell} ( t ) = {V}_{T} ln ( \frac{{I}_{p h} + {I}_{0}}{{I}_{0}} \cdot ( 1 - \frac{{I}_{p h}}{{I}_{p h} + {I}_{0} \cdot {\text{?}}^{t \cdot \frac{{I}_{p h} + {I}_{0}}{{C}_{cell} \cdot {V}_{T}}}} ) ) \qquad ( 15 )$$

$$\text{?} \text{indicates text missing or illegible when filed}$$

As can be seen from equations (14) and (15), the operating point of the solar panel 102 depends on the capacitance Ccell of the CDI cell 104. Thus, appropriate control of the capacitance C_{cell} (i.e. of the capacitor 114) may lead to optimized production of electrical power from the solar panel 102 for operation of the CDI cell 104.

Furthermore, variation of the output concentration is directly related to the water flow passing across the CDI cell 104, as follows:

$$V \cdot \frac{dC}{dt} F \cdot ( {C}_{i n} - C ) - {\text{?}}_{salt} \qquad ( 16 )$$

$$\text{?} \text{indicates text missing or illegible when filed}$$

where F (ml/s) is the volumetric water flow rate through the CDI cell 104, Cin (mM) is the water concentration of the influent, V (ml) is the actual volume of the CDI cell 104, and @salt (mmol/s) is the amount of ions removed per time unit from the feed water during the adsorption phase.

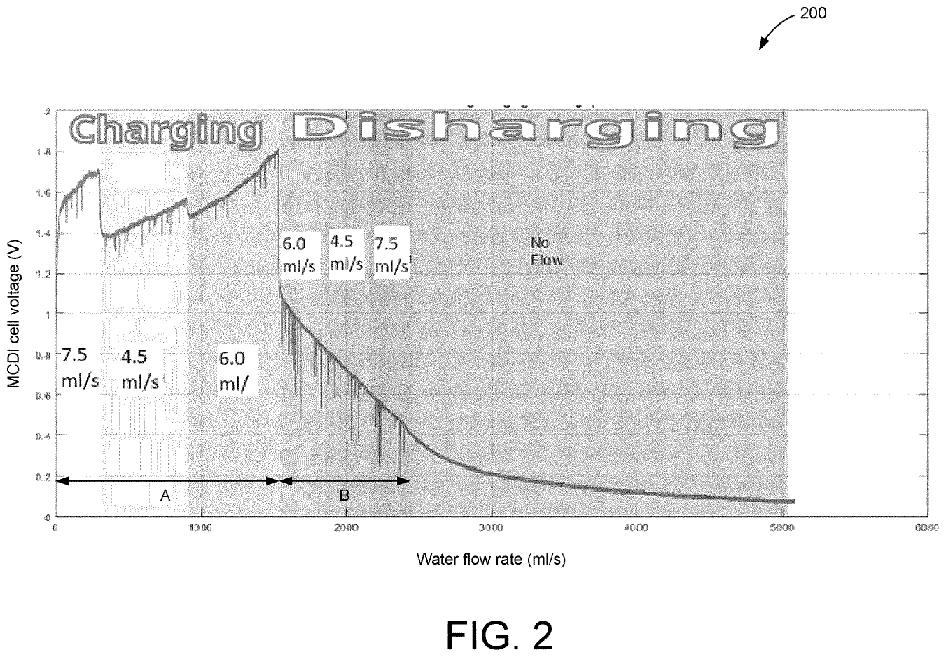

Under the same operating conditions, increasing the water flow rate through the CDI cell 104 will result in increasing the output concentration. This is due to the CDI cell's electrode retaining ions capacity for a given applied charging current. It is also noticeable that the CDI cell's adsorption period (i.e. the duration of the adsorption phase) may be longer with a lower water flow since the CDI cell's electrodes are not saturated with ions due to the limited amount of ions in the effluent. Thus, it may take more time to achieve a desired voltage charge level on the terminals 103 of the CDI cell 104. In other words, the voltage V_{cell} of the CDI cell 104 is closely related to the water flow rate in the adsorption period. This is illustrated in FIG. 2, which shows a plot 200 of the voltage V_{cell} of the CDI cell 104 as a function of the water flow rate through the CDI cell 104. As can be seen from plot 200, in the adsorption period (labelled with arrow “A” in FIG. 2), as the water flow rate increases, the slope of the CDI cell charging voltage increases. Plot 200 also shows that, in the desorption period (labelled with arrow “B” in FIG. 2), the water flow rate seems to have no noticeable effect on the CDI cell discharging voltage.

As the CDI cell charging voltage increases (in the adsorption period A), the electrodes of the CDI cell 104 are able to retain more ions, such that a higher water flow rate through the CDI cell 104 will bring more ions in between the electrodes and will stabilize the CDI cell's output concentration. Therefore, for a variable applied voltage on the CDI cell 104, it may be desirable to control the flow rate of the feed water passing through the CDI cell 104 in order to maintain a fixed output concentration.

Furthermore, since the curve of the CDI cell charging voltage is affected by the variation in the water flow rate through the CDI cell 104, the capacitance C_{cell} of the capacitor 114 will be closely related to the water flow rate through the CDI cell 104. Such capacitance may be calculated as follows:

$${C}_{cell} = \frac{I}{tan α} \qquad ( 17 )$$

where I is the charging current of the CDI cell 104, as mentioned above, and a is the slope of the voltage V_{cell} of the CDI cell 104.

Equation (17) illustrates the inversely proportional relationship between the water flow rate through the CDI cell 104 and the capacitance C_{cell} of the CDI cell's capacitor 114. This inversely proportional relationship is due to the time that the CDI cell 104 takes to saturate its electrodes during different flow applications. Because the quantity of adsorption is related to the electrode capacity of ions rather than to the applied water flow rate, the amount of salt removed from the feed water is similar for each water flow rate at the end of the desalination phase.

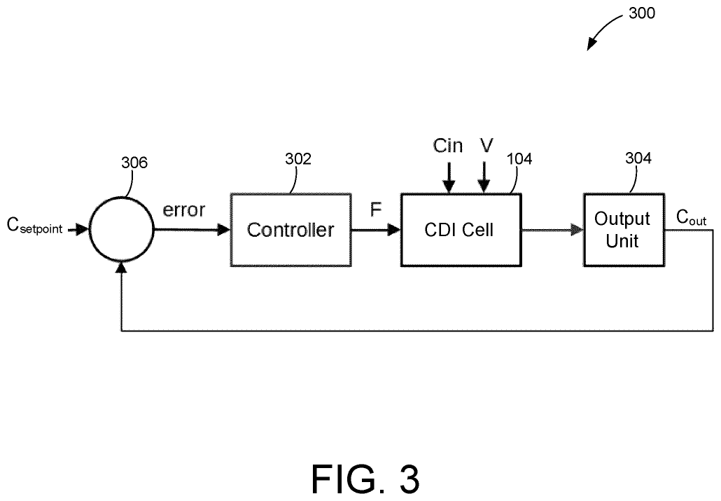

FIG. 3 shows a block diagram 300 illustrating the closed-loop control performed on the CDI cell 104, and more particularly on its output (or “effluent”) concentration (labelled “Cout” in FIG. 3), in accordance with one embodiment. A controller 302 is used to control the volumetric water flow rate (labelled “F” in FIG. 3) through the CDI cell 104 in order to keep the output concentration of the CDI cell 104 substantially constant (i.e. at a desired concentration level). Any suitable controller 302 may be used. In one embodiment, the controller 302 is a proportional-integral-derivative (PID) controller. Any other suitable controller may be used.

In one embodiment, the controller 302 constantly adjusts the water flow rate through the CDI cell 104 based on the actual effluent output of the CDI cell 104, the water concentration Cᵢₙ (mM) of the influent (e.g., feed water), and the actual volume V (ml) of the CDI cell 104. For this purpose, the concentration Cₒᵤₜ of the actual effluent output of the CDI cell 104 is determined by an output unit 304 that is coupled to the output of the CDI cell 104. The output unit 304 provides the output concentration Cₒᵤₜ to a junction 306, where a difference (or error) between a concentration setpoint Cₛₑₜₚₒᵢₙₜ and the output concentration Cₒᵤₜ received from the output unit 304 is computed. Although the junction 306 is illustrated herein as being separate from the controller 302, it should be understood that the junction 306 may be integrated with the controller 302 such that the latter receives the output concentration and compares the output concentration to the concentration setpoint (i.e. computes the error therebetween). The concentration setpoint corresponds to a desired output effluent concentration and may be pre-determined, based on testing results. The value of the concentration setpoint may therefore vary depending on the configuration of the CDI cell 104. In one embodiment, the concentration setpoint is set to a value within the actual operating range of the CDI cell 104 (i.e. to a value below the operational concentration limit) of the CDI cell 104. The error is then provided to the controller 302, which determines the required water flow rate F through the CDI cell 104 based on the error.

In one embodiment, the controller 302 applies a power tracking technique referred to as “perturb and observe”, which is based on the perturbation of the flow rate of the CDI cell 104 powered by the solar panel 102. In particular, following an initial flow perturbation (i.e. an initial change in the water flow rate, referred to herein as the “current” flow perturbation), the controller 302 monitors the variation in the output concentration of the CDI cell 104 and the variation in the power consumed by the CDI cell 104 in order to determine the required adjustment to the water flow rate, i.e. the subsequent flow perturbation (also referred to herein as the “next” flow perturbation) for the CDI cell 104. This is illustrated in Table 1 below, which provides the subsequent flow perturbation as a function of the current flow perturbation, the change in output concentration, and the change in power consumed by the CDI cell 104. Controlling the water flow rate results in an adjustment of the capacitance of the CDI cell 104 and consequently in an adjustment of the impedance load on the solar panel 102. The load variation will then result in a voltage and current variation, and therefore in a change in the power consumed by the CDI cell 104. In one embodiment, the controller 302 is configured to control the water flow rate depending on whether the solar panel 102 is operating power on the left of (i.e. producing less voltage than at) its maximum power point (MPP) or right of (i.e. producing more voltage than at) its MPP, where the MPP refers to the operating point at which it is possible to obtain maximum power from the solar panel 102.

TABLE 1

| Flow | Change of Output | Power | Next Flow |
|---|---|---|---|
| perturbation | Concentration | Change | perturbation |
| positive | negative | positive | positive |
| positive | negative | negative | negative |
| negative | negative | positive | negative |
| negative | negative | negative | positive |
| positive | positive | — | negative |
| negative | positive | — | negative |

As can seen from Table 1, if an increase in power consumed by the CDI cell 104 is measured following the initial flow perturbation, it is proposed herein to keep the subsequent flow perturbation the same in order to reach the MPP. For example, if the change in power consumed by the CDI cell 104 is positive and the current flow perturbation is positive, the controller 302 applies a positive subsequent flow perturbation (see first line of Table 1). In one embodiment, the positive subsequent flow perturbation has the same step size as the previous flow perturbation. If the change in power consumed by the CDI cell 104 is positive and the current flow perturbation is negative, the controller 302 applies a negative subsequent flow perturbation (see third line of Table 1). In contrast, if a decrease in power is measured, it is proposed herein to reverse the subsequent flow perturbation. For example, if the change in power consumed by the CDI cell 104 is negative and the current flow perturbation is positive, the controller 302 applies a negative subsequent flow perturbation (see second line of Table 1). If the change in power consumed by the CDI cell 104 is negative and the current flow perturbation is negative, the controller 302 applies a positive subsequent flow perturbation (see fourth line of Table 1).

If the output concentration is decreasing (i.e. the change in output concentration is negative), the controller 302 continues operating on (i.e. adjusting) the flow to optimize the power produced from the solar panel 102. This is seen in the first four lines of Table 1, where the subsequent flow perturbation alternates between positive and negative depending on the current flow perturbation and on the change in power consumed by the CDI cell 104, as discussed above. As soon as the output concentration increases (i.e. the change in output concentration becomes positive, meaning that the actual output concentration is above the concentration setpoint), the controller 302 attempts to maintain the output concentration by decreasing the flow (i.e. the subsequent flow perturbation is negative, as seen in the fifth and sixth lines of Table 1) to increase the capacitance of the CDI cell 104 and decrease the load on the solar panel 102.

In one embodiment, the controller 302 determines the subsequent flow perturbation and outputs corresponding instructions to a flow control device (not shown) which may be interposed between the controller 302 and the CDI cell 104. The flow control device may be fluidly connected to the CDI cell 104 and configured to control the water flow rate therethrough based on the instructions received from the controller 302. In one embodiment, the flow control device is a DC motor configured to control the operation of the pump that supplies the CDI cell 104 with feed water. In another embodiment, the flow control device is a valve configured to control the supply of feed water from the pump to the CDI cell 104. Any other suitable flow control device may apply.

In one embodiment, the adjustment process illustrated in Table 1 (i.e. the method for controlling the water flow rate through the CDI cell 104) is repeated by the controller 302 periodically, at any suitable time interval, until the MPP is reached, at which point oscillation about the MPP may occur. In some embodiments, the step size in the flow perturbation (i.e. the decrement or increment value of the water flow rate) may be reduced in order to minimize the oscillation. A variable step size may also be used, where a larger step size is used at the beginning and at the end of the adjustment process and a smaller step size is used in between. The step size would depend on the accuracy of the flow control device. In some embodiments, the step size may be fixed and limited to a particular value (e.g., 2 mV) if such a value can make a different to the flow.

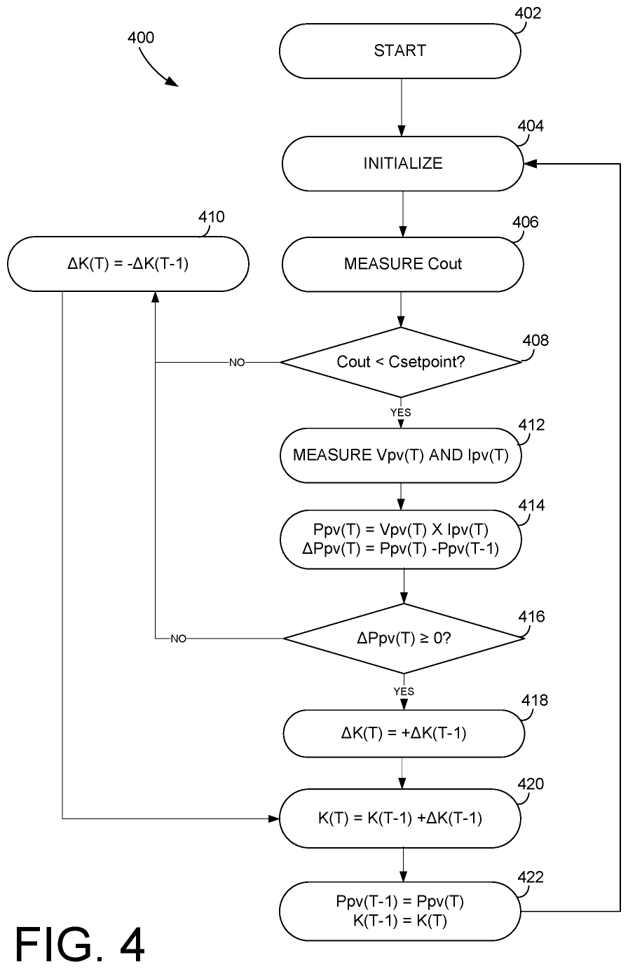

FIG. 4 is a flowchart 400 illustrating the adjustment process performed by the controller 302, as described herein above with reference to FIG. 3. Following start (step 402) and an initialization step (step 404) where the overall system is put in function and flow is directed through the CDI cell 104, the output concentration Cₒᵤₜ of the CDI cell 104 is measured at step 406, e.g. using a concentration probe coupled to an effluent product tank that receives the desalted water output by the CDI cell 104. The output concentration is then compared to the concentration setpoint Cₛₑₜₚₒᵢₙₜ. In particular, it is assessed at step 408 whether the output concentration is lower than the concentration setpoint. If this is not the case (i.e. the output 410 concentration is greater than or equal to the concentration setpoint, meaning that the change in output concentration is positive), the flow perturbation (i.e., the change in water flow rate, ΔK(T)) is set to be the inverse of the previous flow perturbation (i.e. set to −ΔK(T−1)) at step 410. Otherwise, if the output concentration is lower than the concentration setpoint (meaning that the change in output concentration is negative), the voltage and the current of the solar panel (VDv(T) and Ipv(T), respectively) are measured at step 412, e.g. using a suitable measurement device. At step 414, the power (Ppv(T)) currently consumed by the CDI cell 104 is then computed as the product of the voltage VDv(T) and the current Ipv(T), and the change (ΔPpv(T)) in power consumed by the CDI cell 104 is computed as the difference between the power currently consumed (Ppv(T)) and the previously-consumed power (Ppv(T−1)).

The next step 416 is then to assess whether the change in power consumed by the CDI cell 104 is greater than or equal to zero (i.e. positive). If this is not the case, i.e. the change in power consumed by the CDI cell 104 is negative, the method 400 flows back to step 410 where the flow perturbation (ΔK(T)) is set to be the inverse of the previous flow perturbation (i.e. set to −ΔK(T−1)). If it is determined at step 416 that the change in power consumed by the CDI cell 104 is positive, the flow perturbation (ΔK(T)) is set to be the same as the previous flow perturbation (i.e. set to +ΔK(T−1)) at step 418. At step 420, after the flow perturbation (ΔK(T)) has been determined at step 410 or step 418, the water flow rate (K(T)) is computed by adding the flow perturbation to the previous water flow rate (K(T−1)). At step 422, the power (Ppv(T)) currently consumed by the CDI cell 104 (as computed at step 414) is set as the previously-consumed power (Ppv(T−1)) and the flow perturbation (K(T)) determined at step 420 is set as the previous flow perturbation (K(T−1)). The method 400 then flows back to the initialization step 404 and steps 404 to 422 are repeated until the MPP is reached. In one embodiment, the system remain in continuous operation and regulation (i.e. the method 400 is repeated continuously) unless an operator stops the sequence and the system's production.

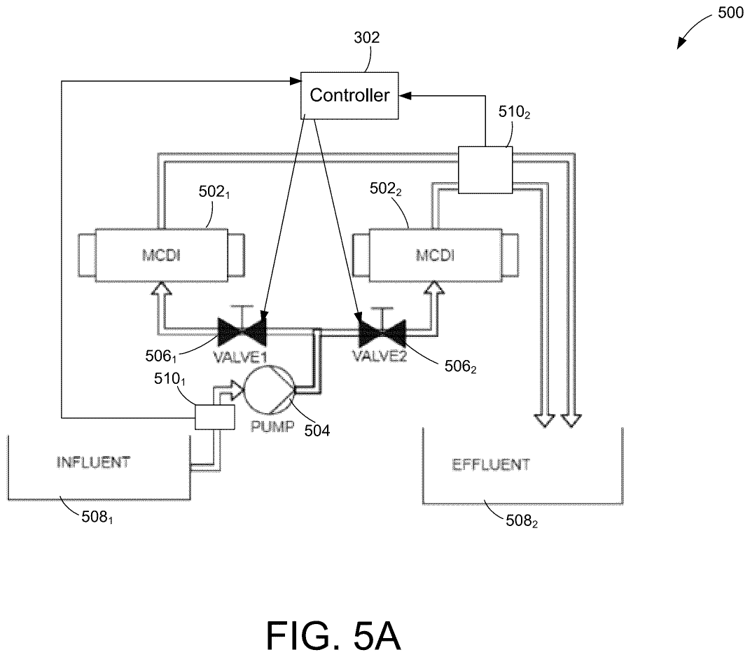

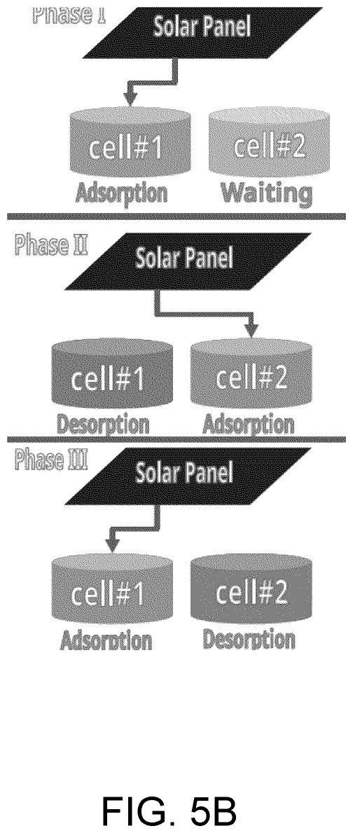

FIG. 5A is a schematic diagram a test bench 500 implemented to validate the systems and methods proposed herein, according to one embodiment. The test bench 500 comprises two MCDI cells 502₁, 502₂ fed with electrical power from a solar panel (not shown) coupled thereto. In one embodiment, two MCDI cells 502₁, 502₂ are used to maintain a continuous operation of the PV-CDI system. It should however be understood that any suitable number of MCDI cells other than two may apply. In one embodiment, the MCDI cells 502₁, 502₂ are of the ESD400 model from Enpar™. It should however be understood that any other suitable MCDI cell may apply. In one embodiment, the MCDI cells 502₁, 502₂ have four-pole connection, namely two poles for positive termination and two poles for negative termination. The terminals (not shown) of the MCDI cells 502₁, 502₂ are connected to carbon electrodes (not shown) separated with several membrane layers.

In operation, and as illustrated in FIG. 5B, the adsorption and desorption phases of the MCDI cells 502₁, 502₂ alternate. In particular, in the first phase of operation (Phase I in FIG. 5B), the first MCDI cell (e.g., MCDI cell 502₁ of FIG. 5A) is powered by the solar panel and enters the adsorption phase of the desalination process, while the second MCDI cell (e.g., MCDI cell 502₂ of FIG. 5A) is waiting to be powered by the solar panel. In the second phase of operation (Phase II in FIG. 5B), the second MCDI cell (e.g., MCDI cell 502₂) is powered by the solar panel and enters the adsorption phase while the first MCDI cell (e.g., MCDI cell 502₁) enters the desorption phase. Finally, in the third phase of operation (Phase III in FIG. 5B), the first MCDI cell (e.g., MCDI cell 502₁) is once more fed by powered solar panel and thus re-enters the adsorption phase while the second MCDI cell (e.g., MCDI cell 502₂) enters the desorption phase. From FIG. 5B, it can be seen that the electrical power from the solar panel can be used concurrently by both MCDI cells (e.g., MCDI cells 502₁, 502₂), during all phases of the desalination process. Furthermore, during electrode cleaning, each MCDI cell regenerates a portion of the consumed energy on its terminal and the energy that is regenerated during the desorption phase of a given cell may be used to power other components of the desalination system.

Referring back to FIG. 5A, the test bench 500 further comprises a pump 504 (e.g. a peristaltic pump) configured to feed water to the MCDI cells 502₁, 502₂ through two adjustable valves 506₁, 506₂. The pump 504 is illustratively equipped with a DC motor (not shown) controlled by the voltage variation through the controller 302. The first valve 506₁ is connected to the first MCDI cell 502₁, 502₂ and the second valve 506₂ is fluidly coupled to the second MCDI cell 502₂. The pump 504 is supplied with feed water from an influent water tank 508₁ equipped with a first probe 510₁ (e.g., a first conductivity measurement probe) connected to the controller 302. Both MCDI cells 502₁, 502₂ push their product (i.e. desalted water) into an effluent tank 508₂ equipped with a second probe 510₂ (e.g., a second conductivity measurement probe) connected to the controller 302. The first probe 510₁ is configured to measure the influent concentration, while the second probe 510₂ is configured to measure the actual effluent output concentration.

The closed loop configuration described herein above with reference to FIG. 3 and FIG. 4 may be programmed into the controller 302 to adjust the speed of the pump 504 and consequently adjust the flow rate of water passing through the MCDI cells 502₁, 502₂. In particular, the controller 302 determines the error (i.e. the difference) between the concentration setpoint and the actual effluent output concentration measured by the second probe 510₂. The controller 302 then uses the error to adjust (in the manner described above with reference to FIGS. 3 and FIG. 4) the operating condition of the MCDI cells 502₁, 502₂ in order to ensure a substantially constant output concentration in the manner described herein above.

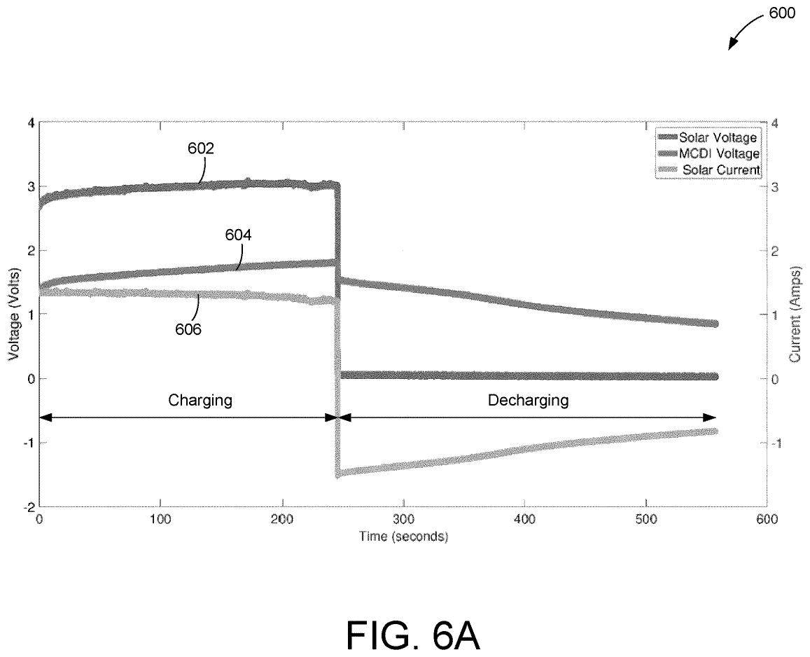

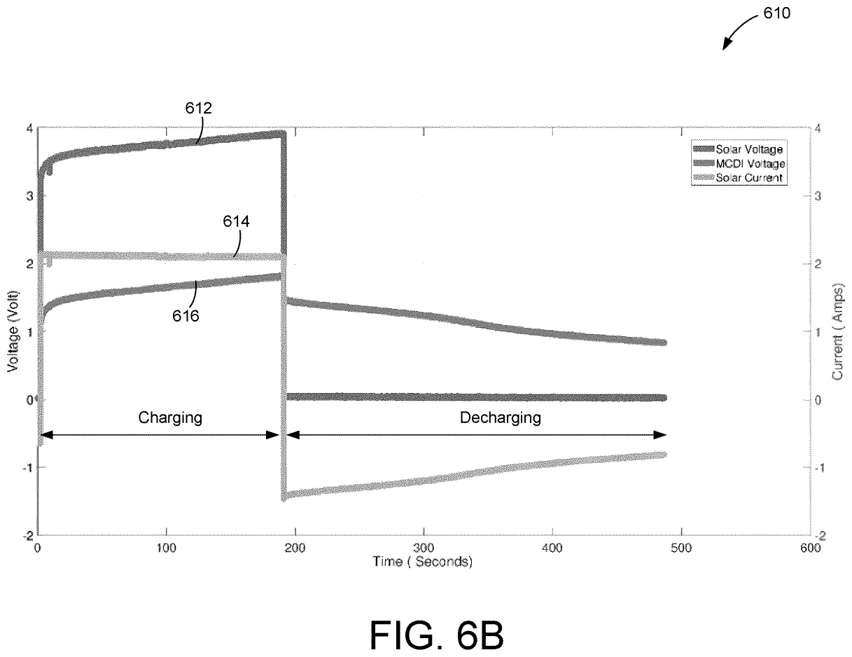

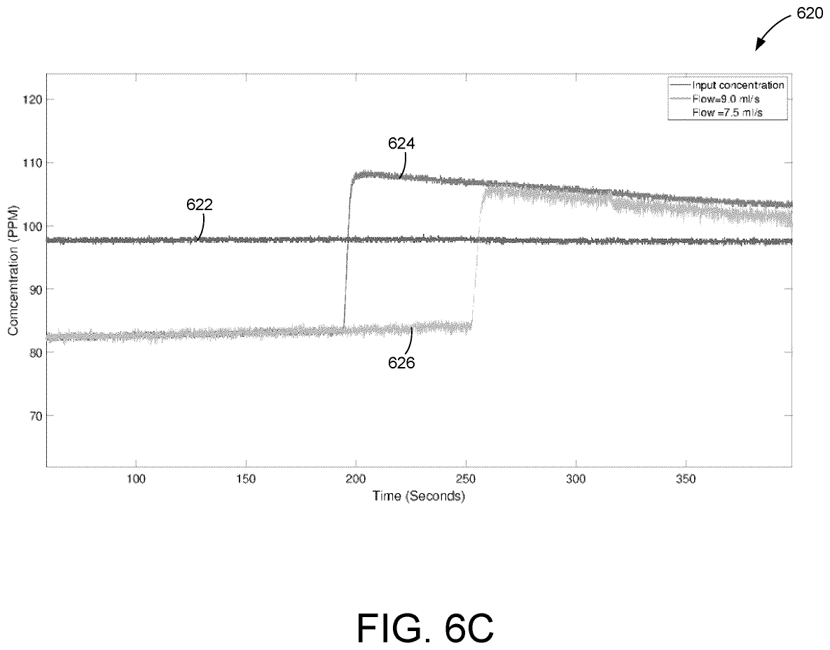

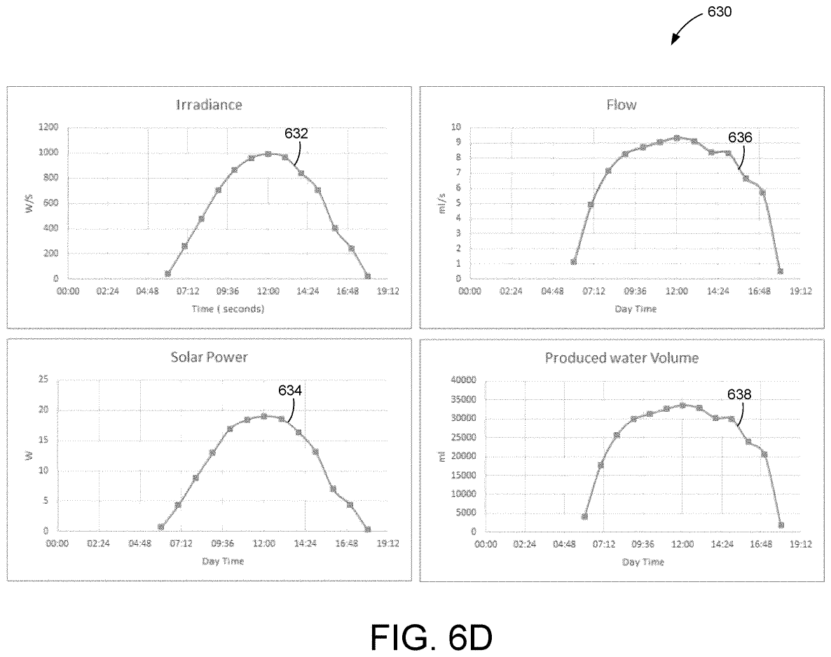

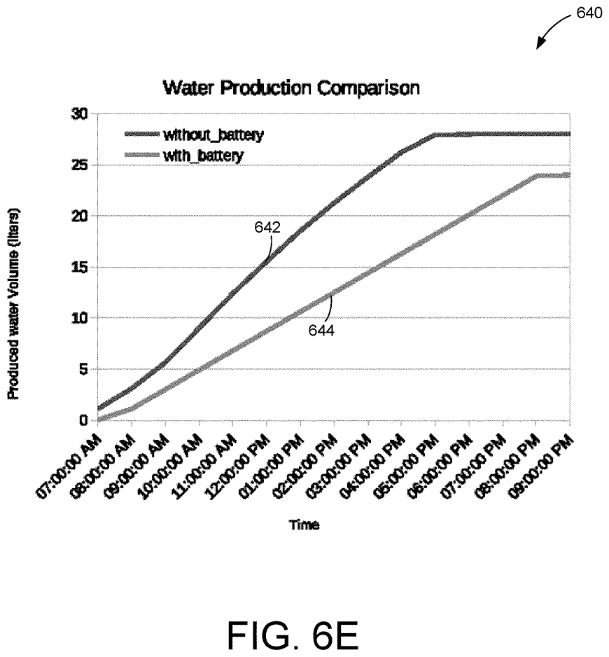

FIG. 6A is a plot 600 illustrating the evolution, during the charging and discharging phases, of the solar voltage (curve 602) applied to a MCDI cell, the voltage of the MCDI cell (curve 604), and the solar current (current 606) following feeding of water at a flow rate of 7.5 ml/s. FIG. 6B is a plot 610 illustrating the evolution, during the charging and discharging phases, of the solar voltage (curve 612) applied to the MCDI cell, the voltage of the MCDI cell (curve 614), and the solar current (current 616) following feeding of water at a flow rate of 9.0 ml/s. It can be seen from FIG. 6A and FIG. 6B that increasing the flow rate of feed water passing through the MCDI cell requires more electrical power from the solar panel (i.e. a higher level of solar voltage and solar current is required when the flow rate is 9.0 ml/s compared to when the flow rate is 7.5 ml/s). FIG. 6C illustrates a plot 620 of the input concentration (curve 622), the output concentration when the flow rate is 9.0 ml/s (curve 624), and the output concentration when the flow rate is 7.5 ml/s (curve 626), as a function oft time. As can be seen from FIG. 6C, using the systems and methods described herein may allow to maintain the output concentration at substantially the same level when the flow rate is 7.5 ml/s or 9.0 ml/s.

FIG. 6D is a plot 630 illustrating the average irradiance profile (curve 632), solar power (curve 634), flow rate to the MCDI cell (curve 636) (as controlled using the systems and methods described herein), and produced water volume (curve 638) as a function of time, during a typical summer day. It can be seen from curve 636 that the systems and methods described herein adjust the water flow rate to substantially match the average irradiance profile. When the irradiance reaches its maximum peak, the systems and methods described herein apply the highest water flow rate, leading to maximum power being fed to the MCDI cell from the solar panel. This in turn results in the water volume produced by the MCDI cell being maximized.

FIG. 6E is a plot 640 illustrating the desalted water volume (curve 642) produced using the systems and methods described herein versus the desalted water volume (curve 644) produced using conventional techniques (e.g., requiring a battery or other energy storage device(s)). As can be seen from FIG. 6E, in some embodiments, the systems and methods described herein may allow to produce more water volume than conventional techniques.

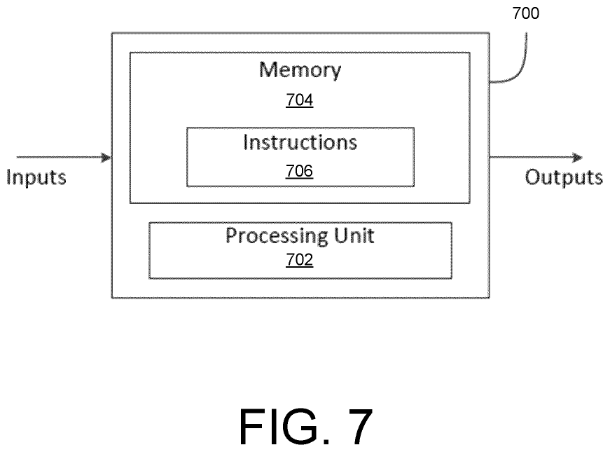

FIG. 7 is a schematic diagram of computing device 700, which may be used to implement the controller 302 of FIG. 3 and/or the method 400 of FIG. 4. The computing device 700 comprises a processing unit 702 and a memory 704 which has stored therein computer-executable instructions 706. The processing unit 702 may comprise any suitable devices configured to implement the functionality of the method 400 such that instructions 706, when executed by the computing device 700 or other programmable apparatus, may cause the functions/acts/steps performed by method 400 as described herein to be executed. The processing unit 702 may comprise, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

The memory 704 may comprise any suitable known or other machine-readable storage medium. The memory 704 may comprise non-transitory computer readable storage medium, for example, but not limited to, an electronic, magnetic, optical, electromagnetic, infrared, or semiconductor system, apparatus, or device, or any suitable combination of the foregoing. The memory 704 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 704 may comprise any storage means (e.g. devices) suitable for retrievably storing machine-readable instructions 706 executable by the processing unit 702.

In one embodiment, since the proposed control method is based on individual MCDI cell operation (i.e. each MCDI cell is controlled individually from remaining MCDI cells) rather than on full desalination at the plant scale, the methods and systems described herein may allow to simplify the desalination plant design. In addition, the methods and systems described herein may alleviate the need for equipment, such as batteries, energy storage systems, DC-to-DC converters, and the like, to be used in the production line, thus simplifying operation, increasing system operational efficiency, and reducing maintenance and troubleshooting costs. In other words, the methods and systems described herein (particularly the application of solar energy on the CDI cell using MSAT) may in some embodiments lead to a more cost effective desalination solution and reduced maintenance compared to existing techniques. The methods and systems described herein also adapt to fluctuations in operating conditions of the desalination plant (i.e. control the flow rate of water passing through the MCDI cell in order to cause the output concentration to be maintained regardless of such fluctuations) and, as such, these fluctuations may not cause a variation in the quality of the produced water. In this manner, high salinity in the product line or high-power consumption for low productivity may be prevented. Also, the methods and systems described herein may allow to implement a silent process that is environmentally friendly and self-supplied, in addition to simplifying installation.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the systems and methods described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be apparent to those skilled in the art that changes and modifications 560 may be made without departing from this invention in its broader aspects. The scope of the following claims should not be limited by the embodiments set forth in the examples, but should be given the broadest reasonable interpretation consistent with the description as a whole.

1. A method for controlling at least one capacitive deionization (CDI) cell used for water desalination, the method comprising:
subsequent to feeding the at least one CDI cell with water at an initial flow rate, obtaining a measurement of an actual output concentration of water exiting the at least one CDI cell;
comparing the actual output concentration to a concentration setpoint;
determining, based on the comparing, a change to be applied to the initial flow rate for adjusting the output concentration towards the concentration setpoint; and
outputting at least one control signal comprising instructions to cause the change to be applied to the initial flow rate to obtain a modified flow rate and to cause the at least one CDI cell to be fed with water at the modified flow rate.

2. The method of claim 1, wherein the at least one CDI cell is fed with electrical power from at least one solar panel, further comprising determining a change in power consumed by the at least one CDI cell subsequent to feeding the at least one CDI cell with water at the initial flow rate, wherein the change to be applied to the initial flow rate is further determined based on the change in power consumed by the at least one CDI cell.

3. The method of claim 2, wherein determining the change to be applied to the initial flow rate comprises determining a decrease in the initial flow rate when the actual output concentration is greater than or equal to the concentration setpoint.

4. The method of claim 3, wherein the change in power consumed by the at least one CDI cell is determined when the actual output concentration is lower than the concentration setpoint.

5. The method of claim 4, wherein determining the change to be applied to the initial flow rate comprises determining an increase in the initial flow rate when the actual output concentration is lower than the concentration setpoint and the change in power consumed by the at least one CDI cell is positive.

6. The method of claim 5, wherein determining the change to be applied to the initial flow rate comprises determining the decrease in the initial flow rate when the actual output concentration is lower than to the concentration setpoint and the change in power consumed by the at least one CDI cell is negative.

7. The method of claim 1, wherein feeding the at least one CDI cell with water comprises feeding multiple CDI cells connected in series.

8. The method of claim 1, wherein feeding the at least one CDI cell with water comprises feeding multiple CDI cells connected in parallel.

9. The method of claim 1, wherein feeding the at least one CDI cell with water comprises feeding multiple CDI cells arranged in a combination of a series arrangement and a parallel arrangement.

10. A system for controlling at least one capacitive deionization (CDI) cell used for water desalination, the system comprising:
a processing unit; and
a non-transitory memory communicatively coupled to the processing unit and comprising computer-readable program instructions executable by the processing unit for:
subsequent to feeding the at least one CDI cell with water at an initial flow rate, obtaining a measurement of an actual output concentration of water exiting the at least one CDI cell;
comparing the actual output concentration to a concentration setpoint;
determining, based on the comparing, a change to be applied to the initial flow rate for adjusting the output concentration towards the concentration setpoint; and
outputting at least one control signal comprising instructions to cause the change to be applied to the initial flow rate to obtain a modified flow rate and to cause the at least one CDI cell to be fed with water at the modified flow rate.

11. The system of claim 10, wherein the at least one CDI cell is fed with electrical power from at least one solar panel, further wherein the instructions are executable by the processing unit for determining a change in power consumed by the at least one CDI cell subsequent to feeding the at least one CDI cell with water at the initial flow rate, wherein the change to be applied to the initial flow rate is further determined based on the change in power consumed by the at least one CDI cell.

12. The system of claim 11, wherein the instructions are executable by the processing unit for determining the change to be applied to the initial flow rate comprising determining a decrease in the initial flow rate when the actual output concentration is greater than or equal to the concentration setpoint.

13. The system of claim 12, wherein the instructions are executable by the processing unit for determining the change in power consumed by the at least one CDI cell when the actual output concentration is lower than the concentration setpoint.

14. The system of claim 13, wherein the instructions are executable by the processing unit for determining the change to be applied to the initial flow rate comprising determining an increase in the initial flow rate when the actual output concentration is lower than the concentration setpoint and the change in power consumed by the at least one CDI cell is positive.

15. The system of claim 14, wherein the instructions are executable by the processing unit for determining the change to be applied to the initial flow rate comprising determining the decrease in the initial flow rate when the actual output concentration is lower than the concentration setpoint and the change in power consumed by the at least one CDI cell is negative.

16. The system of claim 10, wherein the at least one CDI cell comprises multiple CDI cells connected in series.

17. The system of claim 10, wherein the at least one CDI cell comprises multiple CDI cells connected in parallel.

18. The system of claim 10, wherein the at least one CDI cell comprises multiple CDI cells arranged in a combination of a series arrangement and a parallel arrangement.

19. A non-transitory computer readable medium having stored thereon program code executable by a processor for:
subsequent to feeding at least one capacitive deionization (CDI) cell with water at an initial flow rate, obtaining a measurement of an actual output concentration of water exiting the at least one CDI cell;
comparing the actual output concentration to a concentration setpoint;
determining, based on the comparing, a change to be applied to the initial flow rate for adjusting the output concentration towards the concentration setpoint; and
outputting at least one control signal comprising instructions to cause the change to be applied to the initial flow rate to obtain a modified flow rate and to cause the at least one CDI cell to be fed with water at the modified flow rate.
